(19) United States
(12) Patent Application Publication
(10) Pub. No.: US 2020/0360226 A1
(43) Pub. Date: Nov. 19, 2020

(54) VIBRATION DEVICE WITH INTRAORAL AND EXTRAORAL ATTACHMENTS

(71) Applicant: Enoch Trevor Ng, Edmonton (CA)

(72) Inventor: Enoch Trevor Ng, Edmonton (CA)

(21) Appl. No.: 16/854,069

(22) Filed: Apr. 21, 2020

Related U.S. Application Data
(60) Provisional application No. 62/847,754, filed on May 14, 2019.

(51) Int. Cl. A61H 23/00; A61H 13/00; A61H 23/02

(52) U.S. Cl. CPC A61H 23/004; A61H 13/00; A61H 23/02; A61H 2201/1685; A61H 2201/0157; A61H 2201/10; A61H 2201/0153

(57) ABSTRACT

A vibration device includes a device body, and intraoral device, and an extraoral device. The vibration device can include a motor that vibrates the intraoral and extraoral attachments. The vibration device can include a power source configured to selectively activate the motor. The power source can be recharged from a recharging base. The vibration device can include a lighting assembly powered from the power source. The intraoral and extraoral attachments alternately and removably engage the device body. The intraoral attachment can include a brush tray that can include a plurality of bristles. The extraoral attachment can include a massage head. The vibration device can include a body connector member configured to alternately and removably connect the extraoral and the intraoral attachments. The intraoral and extraoral attachments can include a connector shaft configured to directly engage the motor to receive vibration.

### RELATED APPLICATION

The present application claims priority on U.S. Provisional Application Ser. No. 62/847,754 filed on May 14, 2019, and entitled “VIBRATING DEVICE WITH INTRAORAL AND EXTRAORAL ATTACHMENTS”. As far as permitted, the contents of U.S. Provisional Application Ser. No. 62/847,754 are incorporated herein by reference.

### BACKGROUND

Dental and oral hygiene is an important part of one's personal health and appearance. For example, intraorally brushing one's teeth can help by removing plaque and reducing decay, thus improving the appearance of the teeth, while also maintaining the desired strength and health of the teeth. The user can also brush along the gum line to help maintain the health of the gums. Traditionally, teeth cleaning devices are provided in the form of manual toothbrushes, which include a head having bristles, with the head being supported by a handle. More recently, motorized, vibrating toothbrushes have become more popular for users. Such motorized, vibrating toothbrushes are configured to add convenience and enhanced effectiveness to the tooth brushing process. Some motorized toothbrushes require manual movement of a generally linear shaft or handle, so as to guide a head with bristles along the surfaces of the teeth and gums.

Additionally, massage devices have been widely used for massaging stressed or strained extraoral body parts such as backs, shoulders, legs and arms. Maintaining both intraoral and extraoral health and wellness is essential for most everyone's fitness and well-being.

### SUMMARY

The present invention is directed toward a vibration device for use by a user. The vibration device includes a device body, an intraoral attachment that is removably attachable to the device body and an extraoral attachment that is removably attachable to the device body. The intraoral attachment is configured for use within a mouth of the user and the extraoral attachment is configured for use outside the mouth of the user.

In certain embodiments, only one of the intraoral attachment and the extraoral attachment is attachable to the device body at any one time.

In some embodiments, the vibration device includes a motor that is coupled to the device body. In such embodiments, the motor can be configured to selectively vibrate the intraoral attachment when the intraoral attachment is coupled to the device body and to selectively vibrate the extraoral attachment when the extraoral attachment is coupled to the device body. In certain such embodiments, the motor is configured to vibrate at a frequency of between approximately fifty Hertz and four hundred Hertz.

In certain embodiments, the vibration device includes a power source that is electrically connected to the motor. The user can selectively activate the power source to selectively activate the motor. In one embodiment, the power source includes a battery; and the vibration device can further include a recharging base that is configured to recharge the battery.

In some embodiments, the vibration device further includes a lighting assembly that is coupled to the device body. In such embodiments, a power source can be electrically connected to a motor and a lighting assembly. Additionally, in such embodiments, the user selectively activates the power source to selectively activate at least one of the motor and the lighting assembly. The lighting assembly may also be configured to provide at least one of infrared light, near infrared light, visible light, and ultraviolet light to provide a therapeutic effect when used intraorally and extraorally.

In certain embodiments, the intraoral attachment includes a brush tray that is configured to receive a row of teeth of the user. Additionally, the intraoral attachment can further include a plurality of bristles or other suitable protrusions that are coupled or otherwise secured to the brush tray. In some such embodiments, the vibration device includes a motor that is coupled to the device body. The motor is configured to selectively vibrate the brush tray and the plurality of bristles relative to the row of teeth when the intraoral attachment is coupled to the device body.

In some embodiments, the extraoral attachment includes a massage head. The design of the massage head can be varied. For example, in one embodiment, the massage head includes a head base and a plurality of protruding members that are coupled to and extend away from the head base. In another embodiment, the massage head includes a head base and a massage pad that is coupled to the head base. In still another embodiment, the massage head includes a head base and one or more massage balls that are coupled to the head base. In any such embodiments, the vibration device can further include a motor that is coupled to the device body. The motor is configured to selectively vibrate the massage head when the extraoral attachment is coupled to the device body.

In certain embodiments, the vibration device further includes a body connector member for alternately and removably connecting one of the intraoral attachment and the extraoral attachment to the device body.

In some embodiments, the vibration device includes a motor coupled to the device body. In further embodiments, one of the intraoral attachment and the extraoral attachment includes a connector shaft. In further embodiments, the connector shaft directly engages the motor and receives the vibration from the motor.

In certain embodiments, the vibration device includes a body connector member, an intraoral connector member configured to engage the body connector member when the intraoral attachment is alternately and removably coupled to the device body, and an extraoral connector member configured to engage the body connector member when the extraoral attachment is alternately and removably coupled to the device body.

The present invention is also directed toward a vibration device including a device body, a body connector member connected to the device body, an intraoral attachment configured for intraoral use by a user, an extraoral attachment configured for extraoral use by the user, and a motor coupled to the device body. The intraoral attachment and the extraoral attachment selectively and alternately engage the body connector member. The motor is configured to selectively vibrate the intraoral attachment when the intraoral attachment is coupled to the device body and, alternately to selectively vibrate the extraoral attachment when the extraoral attachment is coupled to the device body.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a simplified side view illustration of a portion of a user, and an embodiment of a vibration device having features of the present invention, vibration device including an intraoral attachment that is usable by the user within a mouth of the user;

FIG. 1B is a simplified side view illustration of another portion of the user, and the vibration device illustrated in FIG. 1A, the vibration device including an extraoral attachment that is usable by the user outside the mouth of the user;

FIG. 2A is a simplified front view illustration of an embodiment of the vibration device, including an embodiment of the intraoral attachment;

FIG. 2B is a partially exploded illustration of the vibration device illustrated in FIG. 2A;

FIG. 3A is a simplified front view illustration of another embodiment of the vibration device, including an embodiment of the extraoral attachment;

FIG. 3B is a partially exploded view illustration of the vibration device illustrated in FIG. 3A;

FIG. 4 is a simplified front view illustration of still another embodiment of the vibration device including another embodiment of the extraoral attachment;

FIG. 5 is a simplified front view illustration of yet another embodiment of the vibration device including still another embodiment of the extraoral attachment;

FIG. 6 is a simplified front view illustration of another embodiment of the vibration device, including another embodiment of the intraoral attachment;

FIG. 7A is a partially exploded simplified front view illustration of another embodiment of the vibration device, including the intraoral attachment;

FIG. 7B is a simplified front view illustration of another embodiment of the extraoral attachment; and

FIG. 7C is a simplified front view illustration of yet another embodiment of the extraoral attachment.

While embodiments of the present invention are susceptible to various modifications and alternative forms, specifics thereof have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a vibration device that is configured for use by a user both within and outside a mouth of the user. More particularly, as described in detail herein, in various embodiments, the vibration device includes a device body, an intraoral attachment, and an extraoral attachment. As used herein the intraoral attachment and the extraoral attachment are, collectively referred to as “attachment devices”, which can be alternately and removably coupled to the device body. With the designs shown and described herein, the user can removably couple the intraoral attachment to the device body when it is desired to use the intraoral attachment within the mouth of the user. In addition, or alternately, the user can removably couple the extraoral attachment to the device body when it is desired to use the extraoral attachment outside the mouth of the user, e.g., on another part of the body of the user. In some embodiments, the device body is configured to receive one attachment at a time. In other embodiments, the device body is configured to receive more than one attachment at a time.

Additionally, in some embodiments, the vibration device can further include a motor that is positioned within or otherwise coupled to the device body. The motor can be utilized to selectively vibrate one or more of the attachment devices that are coupled to the device body at any given time.

Those of ordinary skill in the art will realize that the following detailed description of the vibration device is illustrative only and is not intended to be in any way limiting. Other embodiments of the vibration device will readily suggest themselves to such skilled persons having the benefit of this disclosure. Reference will now be made in detail to implementations of the vibration device as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

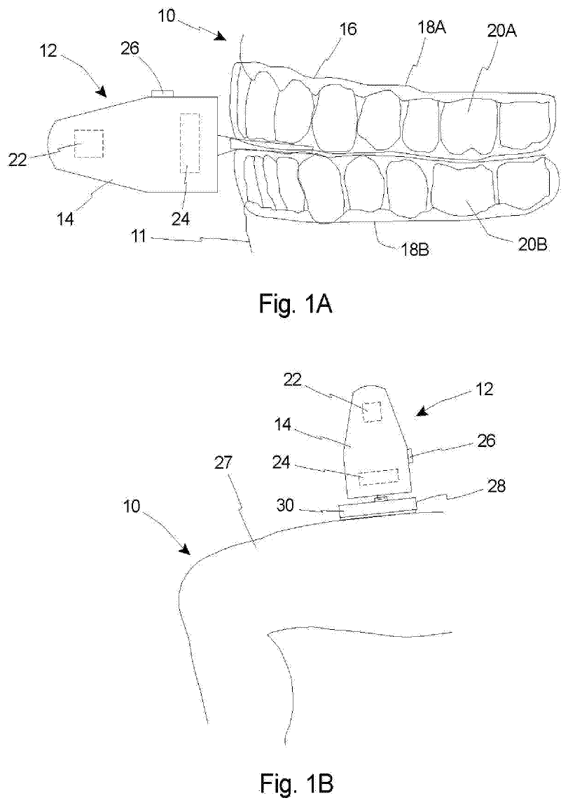

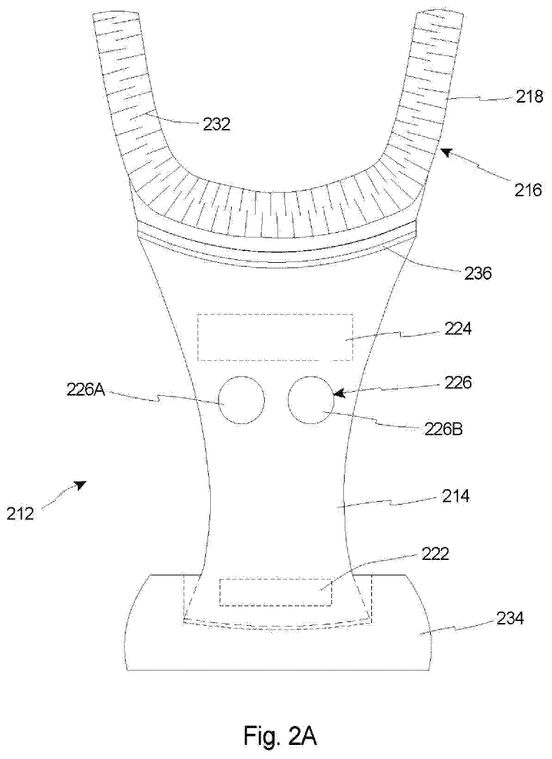

FIG. 1A is a simplified side view illustration of a portion of a user 10, e.g., a mouth 11 of the user 10, and an embodiment of a vibration device 12. The design and/or configuration of the vibration device 12 can be varied. For example, as shown in the embodiment illustrated in FIG. 1A, the vibration device 12 can include a device body 14 and an intraoral attachment 16 that is removably attachable to the device body 14 and that is usable intraorally (within the mouth 11 of the user 10). Additionally, in such embodiments, the vibration device 12 can further include an extraoral attachment 28 (illustrated in FIG. 1B) that is removably attachable to the device body 14 and that can be usable extraorally (outside the mouth 11 of the user 10).

The design of the device body 14 can be varied to suit the specific requirements of the vibration device 12. For example, in some embodiments, the device body 14 can be ergonomically-shaped and can function as a handle to be grasped by the user 10 during use of the vibration device 12. Alternatively, the device body 14 can have any other suitable shape.

During use of the vibration device 12 including the intraoral attachment 16, i.e. when the intraoral attachment 16 is coupled to the device body 14, the device body 14 can be positioned outside the mouth 11 of the user 10, while the intraoral attachment 16 is positioned at least substantially within the mouth 11 of the user 10. The intraoral attachment 16 and extraoral attachment 28 may be removably coupled or attached to the device body 14.

In one embodiment, the intraoral attachment 16 can include a generally arch-shaped, first brush tray 18A that can be configured to selectively receive the upper teeth 20A of the user 10, and a generally arch-shaped, second brush tray 18B that is configured to selectively receive the lower teeth 20B of the user 10. Alternatively, the intraoral attachment 16 can be configured to include only a single brush tray, i.e. either a first brush tray 18A or a second brush tray 18B. Still alternatively, the intraoral attachment 16 can have another suitable design that is configured for use within the mouth 11 of the user. It is understood that the terms “first brush tray” and “second brush tray” are provided for ease of understanding, and that either brush tray 18A, 18B, can be the first brush tray or the second brush tray and can receive the upper teeth 20A or the lower teeth 20B of the user 10. It is further understood that the “first brush tray” and “second brush tray” can be any type of suitable oral appliance, such as, for example, essix trays, configured to receive the upper teeth 20A or the lower teeth 20B.

The intraoral attachment 16, e.g., the brush trays 18A, 18B, can have any suitable design and/or configuration. The brush trays 18A, 18B may be custom fit to the teeth 20A, 20B of the user 10. For example, in certain embodiments, the brush trays 18A, 18B can be formed as flexible, clear plastic or polyurethane shells that conform to the contours of the teeth of the user 10, and thus at least partially encapsulate the teeth of the user 10, so as, for example, to aid in the delivery of topical medications or maintenance of tooth position and tooth retention. More particularly, in such embodiments, the first (upper) brush tray 18A can be configured to conform to the contours of, and at least partially encapsulate the upper teeth 20A of the user 10, and the second (lower) brush tray 18B can be configured to conform to the contours of, and at least partially encapsulate the lower teeth 20B of the user 10. Further, in some embodiments, the brush trays 18A, 18B can be removable, exchangeable, and/or replaceable so that the vibration device 12 can be used with other brush trays that are specific to different users 10. In certain embodiments, the topical medications can be agitation activated or light activated.

As provided herein, in certain embodiments, the vibration device 12 can also include a power source 22 (illustrated in phantom), e.g., a battery, which may or may not be rechargeable, or an AC power source, and a motor 24 (illustrated in phantom) that is electrically coupled to the power source 22. During use of the vibration device 12, the power source 22 can be selectively activated by the user 10, e.g., by pushing on one or more power buttons 26 or controls (one power button 26 is illustrated in FIG. 1A), to selectively activate the motor 24. It is appreciated that the one or more power buttons 26 can be utilized so that the vibration device 12 functions simply in an on/off manner, or the one or more power buttons 26 can be operable to selectively activate the motor 24 at different settings, e.g., high vibration, medium vibration, low vibration, and off settings. The motor 24 can thus be used to vibrate the intraoral attachment 16, as desired, when the intraoral attachment 16 is coupled to the device body 14. In certain applications, the vibration of the motor 24 can help “seat” the brush trays 18A, 18B more directly against the teeth 20A, 20B of the user 10. In certain embodiments, the vibration of the motor 24 can help “seat” custom fit brush trays such as, for example, essix trays, against the teeth 20A., 20B of the user 10. Further, or in the alternative, the intraoral attachment 16 can be manually moved by the user 10, e.g., within the mouth 11 of the user 10. Thus, in some such embodiments, the vibration device 12 can be configured without the power source 22 and/or without the motor 24.

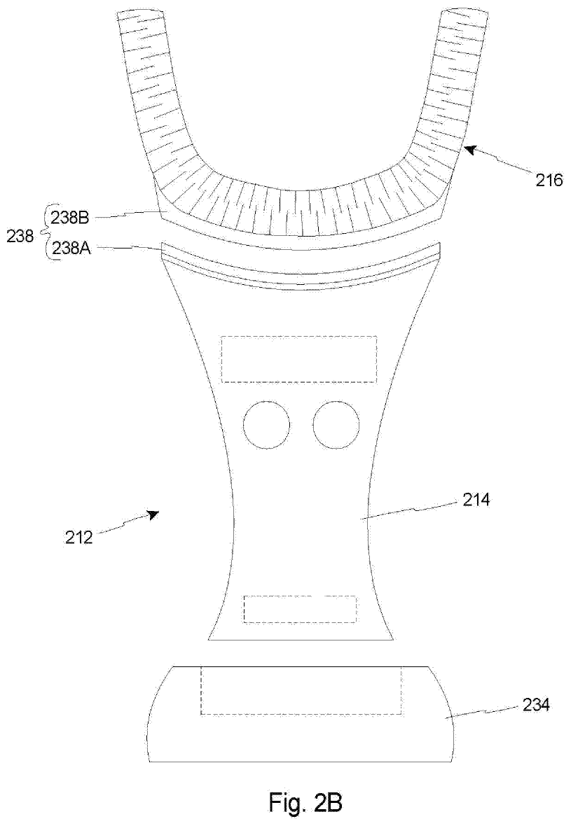

In some embodiments, the vibration device 12 can further include a lighting assembly 236 (illustrated in FIG. 2A) that can indicate when the power source 22 and/or the motor 24 have been selectively activated by the user 10. The lighting assembly 236 can also indicate the status or condition of other internal components of the vibration device 12 such as, for example, charging status of the power source.

FIG. 1B is a simplified side view illustration of another portion of the user 10, e.g., a leg 27 of the user 10, and the vibration device 12 illustrated in FIG. 1A. Additionally, as shown in FIG. 1B, the vibration device 12 includes the device body 14 and an extraoral attachment 28 that is selectively coupled to the device body 14. The vibration device 12 is usable by the user 10 outside the mouth 11 (illustrated in FIG. 1A) of the user 10, e.g., on the legs 27, the arms, the shoulders, and/or the back of the user 10. In some embodiments, the extraoral attachment 28 can be provided in the form of a massage head 30 that is selectively coupled to the device body 14. It is appreciated that the massage head 30 can have any suitable design to provide the desired massage sensations for the user 10. Alternatively, the extraoral attachment 28 can have another suitable design for use by the user 10 outside of the mouth 11 of the user 10.

FIG. 1B also illustrates the power source 22 (illustrated in phantom) and the motor 24 (illustrated in phantom) that can be included in certain embodiments of the vibration device 12. As above, during use of the vibration device 12, the power source 22 can be selectively activated by the user 10, e.g., by pushing on the one or more power buttons 26, to selectively activate the motor 24. Further, as above, it is appreciated that the one or more power buttons 26 can be utilized so that the vibration device 12 functions simply in an on/off manner. It is also appreciated that the one or more power buttons 26 can be operable to selectively activate the motor 24 at different settings, e.g., high, medium, low, off settings, or alternatively as a dial with an infinite number of settings. Additionally, it is appreciated that the one or more power buttons 26 can be utilized to activate additional features of the vibration device 12, either separately or concurrently with activation with the motor 24. The motor 24 can thus be used to vibrate the extraoral attachment 28, as desired, when the extraoral attachment 28 is coupled to the device body 14. Further, or in the alternative, the extraoral attachment 28 can be manually moved by the user 10. Thus, in such embodiments, the vibration device 12 can be configured without the power source 22 and/or without the motor 24.

FIG. 2A is a simplified front view illustration of an embodiment of the vibration device 212, including the device body 214 and an embodiment of the intraoral attachment 216 that is selectively coupled to the device body 214. As illustrated, the device body 214 is substantially identical to what was illustrated and described above in relation to FIGS. 1A and 1B. As such, the device body 214 is specifically configured to be alternately, removably coupled to any of the intraoral attachments 216 and/or any of the extraoral attachments 28 (illustrated in FIG. 1B) illustrated and described herein.

The intraoral attachment 216 can have any suitable design. For example, as shown in FIG. 2A, the intraoral attachment 216 can be a teeth-brushing, teeth-whitening attachment that is provided in the form of a single brush tray 218, which could function as either the first (upper) brush tray 18A (illustrated in FIG. 1A) and/or the second (lower) brush tray 18B (illustrated in FIG. 1A). Additionally, or in the alternative, the intraoral attachment 216 can include a pair of brush trays, i.e. the intraoral attachment 216 can include both the first (upper) brush tray 18A and the second (lower) brush tray 18B. Still alternatively, the intraoral attachment 216 can have another suitable design. As a non-limiting example, the intraoral attachment 216 may be configured to brush and/or massage the tongue, inside cheek, or roof of the mouth of the user 10.

The brush tray 218 is configured to receive one row of teeth of the user 10 (illustrated in FIG. 1A), e.g. either the upper teeth 20A (illustrated in FIG. 1A) or the lower teeth 20B (illustrated in FIG. 1A) of the user 10. As above, the brush tray 218 can be formed as a flexible, clear plastic or polyurethane shell which conforms to the contours of the teeth of the user 10, so as to at least partially encapsulate the teeth of the user 10.

In the embodiment illustrated in FIG. 2A the intraoral attachment 216 can include a plurality of bristles 232 or other suitable protrusions that are coupled or otherwise secured to the brush tray 218. The bristles 232 can be flexible and can be formed from any suitable materials, such as nylon, a nylon-polyester blend, natural fibers, or any other suitable materials. During use of the vibration device 212 with the intraoral attachment 216, the bristles 232 can be positioned to contact all surfaces of the teeth when inserted into the mouth 11 (illustrated in FIG. 1A) of the user 10. It is appreciated that any suitable cleaning material, e.g., toothpaste, teeth-whitening gel, etc., can also be used within the brush tray 218 to further enhance the cleaning of the teeth during use of the intraoral attachment 216. More specifically, the selected cleaning material can be added to and/or positioned within the brush tray 218 prior to inserting the brush tray 218, i.e. the intraoral attachment 216, into the mouth 11 of the user 10. Then, when the brush tray 218 is inserted into the mouth 11 of the user 10, the brush tray 218 can be vibrated (with the motor 224) and/or moved manually within the mouth 11 of the user 10, and the cleaning material can thus function to clean the teeth 20A, 20B of the user 10. With this functionality, the brush tray 218 can sometimes be referred to as a “cleaner receiver”.

In some embodiments, the intraoral attachment 216 can include other suitable brushing or cleaning components in addition to or in lieu of the bristles 232. As non-limiting examples, the intraoral attachment 216 may include additional components for cleaning the tongue, the roof of the mouth 11, and/or inside of the cheeks of the user 10. The additional components may include bristles and/or a textured surface, as non-exclusive examples.

It is appreciated that although embodiments of the intraoral attachment 216 are illustrated and/or described herein as including one or more brush trays, the intraoral attachment 216 need not include any brush trays. More particularly, it is appreciated that the intraoral attachment 216 can include any type of device that is configured for use within the mouth 11 of the user 10.

FIG. 2A also illustrates the power source 222 (illustrated in phantom) and the motor 224 (illustrated in phantom) that is electrically coupled, either wirelessly or via a wired connection, to the power source 222.

The power source 222 can have any suitable design to provide the desired power for the vibration device 212. For example, in one embodiment, the power source 222 includes one or more chargeable or non-rechargeable batteries that can be positioned within the device body 214. Alternatively, the power source 222 can be an AC power source. Further, the power source 222 may be one or more super capacitors or any other power source capable of operating the vibration device 212 for its intended purpose.

In the embodiment illustrated in FIG. 2A, the vibration device 212 can also include a recharging base 234 that can be used to recharge the power source 222, e.g. recharge the batteries. More particularly, when it is determined that the batteries are running relatively low on power, or when otherwise desired, the device body 214 can be positioned at least partially within the recharging base 234 to thus recharge the batteries. The recharging base 234 can have any suitable design that is capable of recharging the power source 222. For example, the recharging base 234 may utilize wireless charging to recharge the power source 222. The recharging base may also utilize wired contacts (not shown) to recharge the power source 222.

In the embodiment illustrated in FIG. 2A, the vibration device 212 can further include a lighting assembly 236 that is coupled to the device body 214. As described herein, in such embodiments, the lighting assembly 236 can be configured to enhance the functionality of the intraoral attachment 216. For example, in one non-exclusive embodiment, the lighting assembly 236 can include a blue light that can be used in conjunction with a whitening gel to enhance/whiten the teeth of the user 10. Additionally, or in the alternative, the lighting assembly 236 can include near-infrared light that can provide therapeutic benefit for the tissue within the mouth 11 of the user 10 or for a location on the body of the user 10 when used extraorally. Alternatively, the lighting assembly 236 can include infrared light, ultraviolet light, and/or visible light to increase the therapeutic effectiveness of the vibration device 212, whether used intraorally or extraorally. Still alternatively, the lighting assembly 236 can include and/or incorporate other suitable lighting features or designs. The lighting assembly 236 may include one or more LEDs as a source of light and/or any other source of light suitable for the intended purpose of the vibration device 212. One or more power buttons 226 can be utilized to selectively activate the lighting assembly 236. In some non-limiting embodiments, the lighting assembly 236 is configured to activate light activated topical medications.

In some embodiments, the lighting assembly 236 can indicate the status of internal functions of the vibration device 212 through the use of specific colors and/or blinking patterns. The lighting assembly 236 can include one or more individual indicator lights (not shown) that can be configured to indicate the internal status of one or more internal components of the vibration device 212.

The motor 224 can be configured to operate at any desired vibrational frequency for vibrating the intraoral attachment 216 in any desired manner. For example, in certain non-exclusive embodiments, the motor 224 can be configured to operate at a vibrational frequency that is adjustable between approximately one hundred Hertz (100 Hz) and two hundred Hertz (200 Hz). In other non-exclusive embodiments, the motor 224 can be configured to operate at a vibrational frequency that is adjustable between approximately fifty Hertz (50 Hz) and four hundred Hertz (400 Hz). Alternatively, the motor 224 can be configured to operate at a vibrational frequency of greater than four hundred Hertz or less than fifty Hertz. The adjustment may be discreet or infinite.

The power source 222, the motor 224 and/or the lighting assembly 236 can be activated in any suitable manner. For example, in some embodiments, the vibration device 212 can include one or more power buttons 226 or controls that selectively activate the power source 222, the motor 224, the lighting assembly 236, and/or any other feature or attachment that may require activation. In the embodiment illustrated in FIG. 2A, the vibration device 212 can include a first power button 226A that selectively activates the power source 222 to selectively activate the vibrational motor 224, and a second power button 226B that selectively activates the power source 222 to selectively activate the lighting assembly 236. In some embodiments, each of the first power button 226A and the second power button 226B can be configured to function simply in an on/off manner, i.e. push once to turn on and push a second time to turn off. Alternatively, the first power button 226A can be operable to selectively activate the motor 224 at different settings, e.g., push once for a high vibrational setting, push a second time for a medium vibrational setting, push a third time for a low vibrational setting, and push a fourth time to turn off. Still alternatively, the second power button 226B can be operable to selectively activate different lights depending on the number of times the second power button is pushed, e.g., push once for blue light, push a second time for near-infrared light, push a third time to activate both the blue light and the near-infrared light, and push a fourth time to turn off. Still alternatively, each of the motor 224 and the lighting assembly 236 can be selectively activated through the use of multiple power buttons, a power dial, a power slider, or in any other suitable manner. As such, the use of the term “power button” is intended to include any configurations of power buttons, power dials, power sliders, etc. Additionally, any such devices can also be referred to generally herein as “power controls”.

FIG. 2B is a partially exploded illustration of the vibration device 212 illustrated in FIG. 2A. In particular, FIG. 2B illustrates the device body 214, the intraoral attachment 216 and the recharging base 234. Additionally, also shown in FIG. 2B is a connector assembly 238 for selectively connecting or coupling the intraoral attachment 216 to the device body 214.

The connector assembly 238 can have any suitable design for the purpose of selectively and removably coupling the intraoral attachment 216 to the device body 214 as desired. For example, the connector assembly 238 can include a body connector member 238A that is connected to the device body 214, and an intraoral connector member 238B that is connected to with the intraoral attachment 216. As used herein, “connected to” can mean integrally formed with, attached to, coupled to, binded to, linked to, affixed to, or any other suitable manner of attachment.

When it is desired to selectively couple the intraoral attachment 216 to the device body 214, the body connector member 238A and the intraoral connector member 238B can be positioned to selectively and mechanically engage and/or retain one another. The specific manner of physical and/or mechanical engagement between the body connector member 238A and the intraoral connector member 238B can be varied as desired. In some embodiments, the body connector member 238A receives a portion of the intraoral connector member 238B. In other embodiments, the intraoral connector member 238B receives a portion of the body connector 238B. As non-limiting examples, the connector assembly 238 can use one or more magnets, snaps, a hook and loop fastener, and/or suction to attach the body connector member 238A to the intraoral connector member 238B. Additional non-limiting examples may include a slide-on style or a twist to lock style connector assembly 238. Alternatively, the connector assembly 238 can have another suitable design for purposes of alternately, removably coupling an attachment device, such as the intraoral attachment 216, to the device body 214.

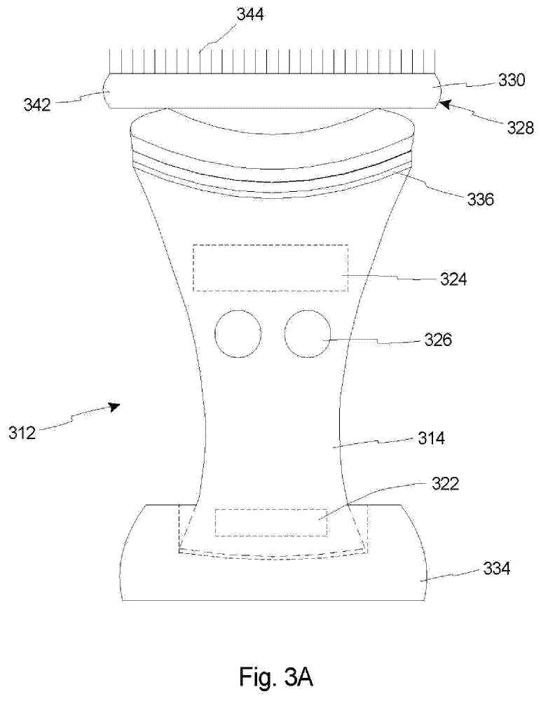

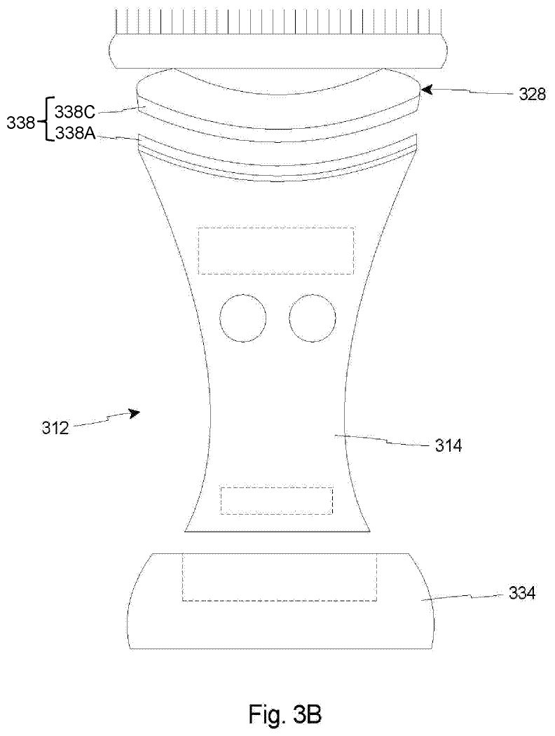

FIG. 3A is a simplified front view illustration of another embodiment of the vibration device 312, including the device body 314 and an embodiment of the extraoral attachment 328 that is alternately, removably coupled to the device body 314. As illustrated, the device body 314 can be substantially similar or identical to those that were previously illustrated and described herein. As such, the device body 314 is specifically configured to be alternately, removably coupled to any of the intraoral attachments 216 (illustrated in FIG. 2A) and/or any of the extraoral attachments 328 illustrated and described herein.

The extraoral attachment 328 can have any suitable design. For example, as shown in FIG. 3A, the extraoral attachment 328 can be provided in the form of a massage head 330 including a substantially flat head base 342 and a plurality of resilient protruding members 344 that are coupled to and extend away from the head base 342. Alternatively, the massage head 330 can include a head base 342 that is somewhat rounded in shape (or another suitable shape), and/or the massage head 330 can be provided without the protruding members 344. Additionally, or in the alternative, it is appreciated that in embodiments that include the protruding members 344, the protruding members 344 can have any suitable shape, which may be different than what is specifically illustrated in FIG. 3A. In one non-exclusive embodiment, the protruding members 344 can include an array of domes, half-spheres or other suitable configurations or geometries disposed on the massage head 330 wherein each dome or half-sphere may be identical in size or shape. Alternatively, each dome or half-sphere may vary in size or shape, to suit a desired function of the vibration device 312. The massage head 330 may also comprise a single somewhat uniform structure that extends from the massage head 330. In another embodiment, the massage head 330 can include one or more indentations (not shown), or a combination of protruding members 344 and indentations. Still alternatively, the extraoral attachment 328 can have another suitable design.

In the embodiment shown in FIG. 3A, the extraoral attachment 328, e.g., the massage head 330, is configured to engage any part of the body of the user 10 (illustrated in FIG. 1B) that the user 10 wants to rub or massage. For example, in some non-exclusive alternative uses of the extraoral attachment 328, the massage head 330 can be used to rub or massage the legs, the arms, the back and/or the shoulders of the user 10. Additionally, as noted above, the plurality of protruding members 344 can be of any suitable number, size, and shape, and can be configured to resiliently and/or movably engage the body of the user 10 during use of the extraoral attachment 328. The extraoral attachment 328 can be used with a topical medication. The topical medication may be agitation activated and/or light activated.

The massage head 330, e.g. the head base 342 and/or the protruding members 344, can be formed from any suitable materials in order to provide any desired sensations as the massage head 330 is being used to rub or massage the body of the user 10.

It is appreciated that although embodiments of the extraoral attachment 328 are illustrated and/or described herein as including a massage head 330, the extraoral attachment 328 need not include a massage head 330. More particularly, it is appreciated that the extraoral attachment 328 can include any type of device that is configured for use outside the mouth 11 (illustrated in FIG. 1A) of the user 10, e.g., devices whose functionality is enhanced through vibrational motion of the device.

FIG. 3A also illustrates the power source 322 (illustrated in phantom) and the motor 324 (illustrated in phantom) that is electrically coupled, either wirelessly or via a wired connection, to the power source 322.

The power source 322 can have any suitable design to provide the desired power for the vibration device 312. For example, in one embodiment, the power source 322 can include one or more rechargeable or non-rechargeable batteries positioned within the device body 314. Alternatively, the power source 322 can include an AC power source.

In the embodiment illustrated in FIG. 3A, the vibration device 312 can also include a recharging base 334 that can recharge the power source 322, i.e. recharge the batteries. More particularly, when it is determined that the power source 322 is running relatively low on power, or when otherwise desired, the device body 314 can be positioned at least partially within the recharging base 334 to thus recharge the power source 322. The recharging base 334 can have any suitable design that is capable of recharging the power source 322. For example, the recharging base 334 may transfer power to the vibration device 312 to recharge the power source 322 using wireless or wired technology.

In various embodiments, the motor 324 can be configured to operate at any desired vibrational frequency for vibrating the extraoral attachment 328 in any desired manner. For example, in certain non-exclusive embodiments, the motor 324 can be configured to operate at a vibrational frequency that is adjustable between approximately one hundred Hertz and two hundred Hertz. In other non-exclusive embodiments, the motor 324 can operate between approximately fifty Hertz (50 Hz) and four hundred Hertz (400 Hz). Alternatively, the motor 324 can be configured to operate at a vibrational frequency of greater than four hundred Hertz or less than fifty Hertz.

In certain embodiments, the power source 322 and/or the motor 324 can be activated in any suitable manner. For example, in some embodiments, the vibration device 312 can include one or more power buttons 326 or controls that are operable to selectively activate the power source 322 and/or the motor 324. In some embodiments, the power buttons 326 can be configured to function simply in an on/off manner, i.e. push once to turn on and push a second time to turn off. Alternatively, the power buttons 326 can be operable to selectively activate the motor 324 at different settings, e.g., push once for a high vibrational setting, push a second time for a medium vibrational setting, push a third time for a low vibrational setting, and push a fourth time to turn off.

In the embodiment illustrated in FIG. 3A, the vibration device 312 can further include a lighting assembly 336 that is coupled to the device body 314. In such embodiments, the lighting assembly 336 can be configured to enhance the functionality of the extraoral attachment 328. Still further, it is appreciated that the power buttons 326 can include separate buttons or controls for selectively activating the vibrational motor 324 and the lighting assembly 336. It is appreciated that the intensity of the lighting assembly 336 may be varied from a low intensity, if not an “off” condition, to a maximum intensity through manipulation of the power controls. In some embodiments the lighting assembly 336 has functions similar to the lighting assembly 236 described above. The intensity may be varied discreetly, i.e. in steps, or infinitely.

FIG. 3B is a partially exploded view illustration of the vibration device 312 illustrated in FIG. 3A. In particular, FIG. 3B again illustrates the device body 314, the extraoral attachment 328 and the recharging base 334. Additionally, also shown more clearly in FIG. 3B is a connector assembly 338 for selectively connecting or coupling the extraoral attachment 328 to the device body 314.

The connector assembly 338 can have any suitable design for purposes of selectively and removably coupling the extraoral attachment 328 to the device body 314 as desired. For example, as shown, the connector assembly 338 can include a body connector member 338A that is connected to the device body 314, and an extraoral connector member 338C that is connected to the extraoral attachment 328.

When it is desired to selectively couple the extraoral attachment 328 to the device body 314, the body connector member 338A and the extraoral connector member 338C can be positioned to selectively and mechanically engage and/or retain one another. The specific physical and/or mechanical engagement between the body connector member 338A and the extraoral connector member 338C can be varied as desired. In some embodiments, the body connector member 338A receives a portion of the extraoral connector member 338C. In other embodiments, the extraoral connector member 338C receives a portion of the body connector 338B. As non-limiting examples, the connector assembly 338 can use one or more magnets, snaps, a hook and loop fastener, and/or suction to attach the body connector member 338A to the extraoral connector member 338C. Additional non-limiting examples may include a slide-on style or twist to lock connector assembly 338. Alternatively, the connector assembly 338 can have another suitable design for purposes of selectively and removably coupling the extraoral attachment 328 to the device body 314.

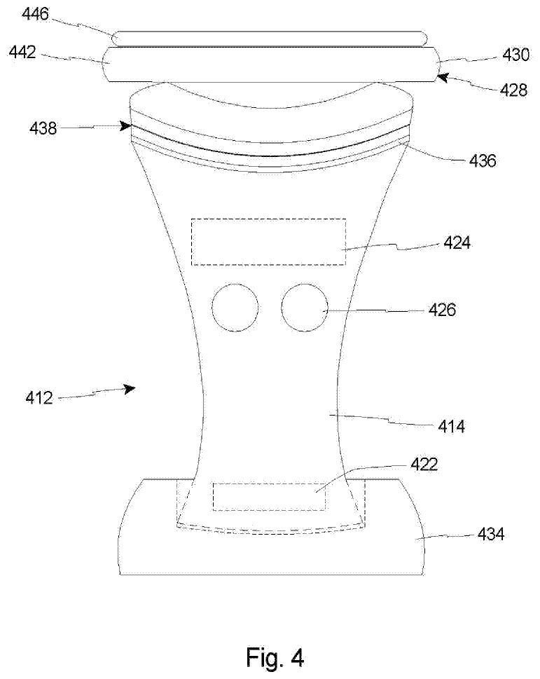

FIG. 4 is a simplified front view illustration of still another embodiment of the vibration device 412, including the device body 414 and another embodiment of the extraoral attachment 428 that is selectively coupled to the device body 414, i.e. through use of a connector assembly 438 such as described above. As illustrated, the device body 414 can be substantially similar or identical to those illustrated and described above in the previous embodiments. The device body 414 is specifically configured to be alternately, removably coupled to any of the intraoral attachments 216 (illustrated in FIG. 2A) and/or any of the extraoral attachments 428 illustrated and described herein.

The vibration device 412 can include a power source 422, a motor 424, and a lighting assembly 436 that are positioned substantially within and/or are coupled to the device body 414. The power source 422, the motor 424, and/or the lighting assembly 436 can be selectively activated through the use of one or more power buttons 426 or controls. Further, in some embodiments, the vibration device 412 can again include a recharging base 434 for recharging the power source 422 as desired.

In the embodiment illustrated in FIG. 4, the extraoral attachment 428 includes a massage head 430 having a head base 442 and a massage pad 446 that is coupled to the head base 442. In different embodiments, the massage pad 446 can have any desired shape, e.g., substantially flat, slightly rounded, contoured, dimpled, etc., and can be formed from any suitable materials in order to provide the desired sensations for the user 10 (illustrated in FIG. 1B). The massage pad 446 can also be used in conjunction with the vibrational motor 424 and/or the lighting assembly 436 in order to enhance the functionality of the vibration device 412 for the user 10.

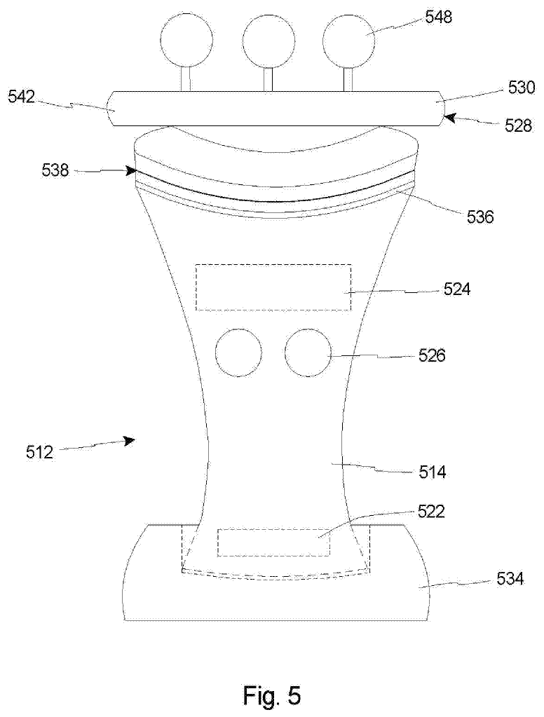

FIG. 5 is a simplified front view illustration of yet another embodiment of the vibration device 512. In this embodiment, the vibration device 512 includes the device body 514 and still another embodiment of the extraoral attachment 528 that is selectively coupled to the device body 514. In the embodiment illustrated in FIG. 5, the extraoral attachment 528 can be coupled to the device body with a connector assembly 538. As illustrated, the device body 514 can be substantially similar or identical to those illustrated and described above. As such, the device body 514 can be specifically configured to be alternately, removably coupled to any of the intraoral attachments 216 (illustrated in FIG. 2A) and/or any of the extraoral attachments 528 illustrated and described herein.

The vibration device 512 can include a power source 522, a motor 524, and/or a lighting assembly 536 that can be positioned substantially within and/or are coupled to the device body 514. Additionally, as above, the power source 522, the motor 524, and/or the lighting assembly are selectively activated through the use of one or more power buttons 526. Further, in some embodiments, the vibration device 512 can again include a recharging base 534 for recharging the power source 522 as desired.

However, in the embodiment illustrated in FIG. 5, the extraoral attachment 528 includes a massage head 530 having a head base 542 and one or more massage balls 548 (three are shown in FIG. 5) that are coupled to the head base 542. In different embodiments, the massage balls 548 can have any desired size and shape, such as cylinders and cones, and can be formed from any suitable materials in order to provide the desired sensations for the user 10 (illustrated in FIG. 1B). The massage balls 548 can also be used in conjunction with the vibrational motor 524 and/or the lighting assembly 536 in order to enhance the functionality of the vibration device 512 for the user 10.

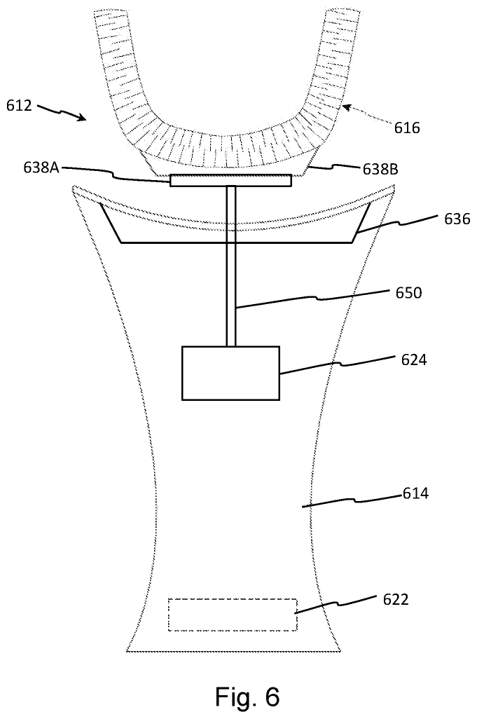

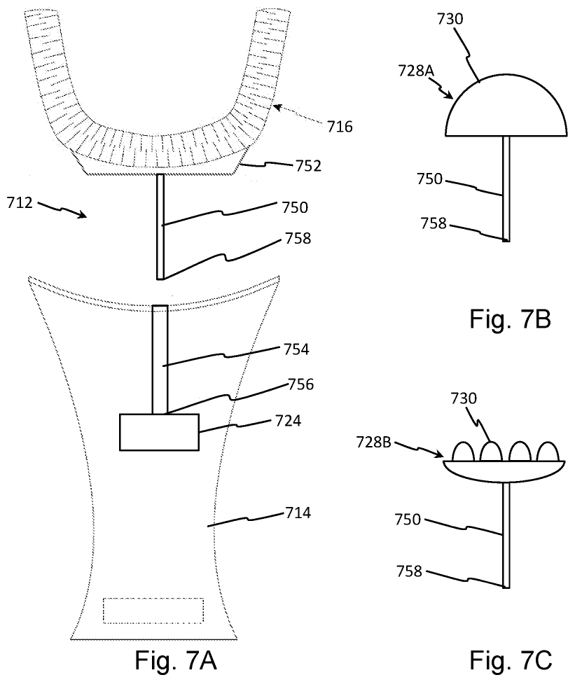

FIG. 6 is a simplified front view illustration of another embodiment of the vibration device 612. In this embodiment, the vibration device includes one or more of a device body 614, a power source 622, a motor 624, a lighting assembly 636, a body connector member 638A, an intraoral connector member 638B, and a connector member 650. As illustrated, the device body 614 can be substantially similar or identical to those illustrated and described above. As such, the device body 614 can be configured to be alternately, removably coupled to the intraoral attachment 616 and/or extraoral attachments 728A, 728B (illustrated in FIGS. 7B and 7C, respectively).

In the embodiment illustrated in FIG. 6, intraoral attachment 616 includes a body connector member 638A. The body connector member 638A is configured to receive the intraoral connector member 638B. For example, the intraoral connector member 638B can include a slot (not shown) into which the body connector member 638A engages and becomes removably attached to the intraoral device 616. It is appreciated the body connector member 638A can include the slot, and the intraoral connector member 638B can engage the body connector member 638A. It is further appreciated that any extraoral attachment or intraoral attachment may have a connector member configured to be removably attached to the body connector member 638A.

In alternative embodiments, the body connector member 638A can engage the intraoral connector member 638B with any other suitable connectors, including, but not limited to one or more magnets, snaps, a hook and loop fastener, and/or suction.

In the embodiment illustrated in FIG. 6, the connector member 650 connects the intraoral connector member 638B to the motor 624. The vibrations generated by the motor 624 are transferred through the connector member 650 to the body connector member 638A, which in turn transfers the vibrational energy to the intraoral connector member 638B. It is appreciated that any structure or mechanism configured to transfer the mechanical energy generated by the motor 624 to the body connector member 638A is fully contemplated herein.

In this embodiment, the lighting assembly 636 can be similar in function to the lighting assembly 236 shown in FIG. 2A and described above. The location of the lighting assembly 636 can allow the light to interact with the intraoral device 616 thereby providing the desired therapeutic effect. It is appreciated that the lighting assembly 636 can be positioned in any portion of the device body 614 where a light transfer structure (not shown) such as one or more light pipes, fiber optics, prisms and/or mirrors, may be used to transfer the light from the lighting assembly 636 to the intraoral device 616.

FIG. 7A is a simplified exploded front view illustration of another embodiment of a vibration device 712. The vibration device 712 comprises an intraoral device 716 and a device body 714. The device body has a motor 724, a device connector receiver 754, and a motor connector interface 756. The intraoral device further 716 comprises an extraoral connector base 752 and a connector shaft 750 attached to the extraoral connector base 752. The connector shaft 750 has a connector shaft interface 758. In some embodiments, the connector shaft interface 758

In some embodiments, the intraoral device 716 is removably attached to the device body 714 by inserting the connector shaft 750 into the device connector receiver 754 such that the connector shaft interface 758 directly engages the motor connector interface 756, which, in some non-exclusive embodiments, may secure the intraoral device 716 in place during use. The vibrations generated by the motor 724 are transferred to the intraoral device 716 through the connector shaft 750 thereby causing the desired effect. When use is complete, the intraoral device 716 may be detached from the device body 714 by removing the connector shaft 750 from the device connector receiver 754.

FIG. 7B is a simplified front view illustration of another embodiment of an extraoral device 728A. The extraoral device 728A comprises a connector shaft 750 having a connector shaft interface 758 and a massage head 730. The massage head 730 is dome-shaped to allow vibration to be applied to a specific point on a user's 10 body. It is to be appreciated that the massage head 730 may be any type or style of therapeutic device usable with the device body 714. The extraoral device 728A is used with the vibrating body 714 in a manner similar to the intraoral device 716 as described above.

FIG. 7C is a simplified front view illustration of another embodiment of an extraoral device 728B. The extraoral device 728B comprises a massage head 730 and a connector shaft 750 having a connector shaft interface 758. The massage head 730 comprises multiple dome-shaped heads, which can be used to allow the vibration created by the motor 724 to be transferred to a broad area, such as a calf or thigh of the user 10. It is to be appreciated that the shape and size of each of the heads on the massage head 730 may vary. The extraoral device 728B is used with the vibrating body 714 in a manner similar to the intraoral device 716 described above.

It is understood that although a number of different embodiments of the vibration device have been illustrated and described herein, one or more features of any one embodiment can be combined with one or more features of one or more of the other embodiments, provided that such combination satisfies the intent of the present invention.

While a number of exemplary aspects and embodiments of the vibration device have been discussed above, those of skill in the art will recognize certain modifications, permutations, additions, and sub-combinations thereof. It is therefore intended that the following appended claims and claims hereafter introduced are interpreted to include all such modifications, permutations, additions and sub-combinations as are within their true spirit and scope.

What is claimed is:

1. A vibration device, comprising:
a device body;
an intraoral attachment that is removably attachable to the device body, the intraoral attachment being configured for intraoral use by a user; and
an extraoral attachment that is removably attachable to the device body, the extraoral attachment being configured for extraoral use by the user.

2. The vibration device of claim 1 wherein only one of the intraoral attachment and the extraoral attachment is attachable to the device body at any one time.

3. The vibration device of claim 1 further comprising a motor that is coupled to the device body, the motor selectively generating vibration that is alternately received by the intraoral attachment and the extraoral attachment.

4. The vibration device of claim 3 wherein the motor is configured to vibrate at a frequency of between approximately 50 Hertz and 400 Hertz.

5. The vibration device of claim 3 further comprising a power source that is electrically connected to and selectively activates the motor.

6. The vibration device of claim 5 wherein the vibration device further includes a recharging base that is configured to recharge the power source.

7. The vibration device of claim 1 further comprising a lighting assembly that is coupled to the device body.

8. The vibration device of claim 7 further comprising a power source and a motor that is electrically connected to the power source, the power source being configured to selectively activate at least one of the motor and the lighting assembly.

9. The vibration device of claim 7, wherein the lighting assembly is configured to provide at least one of infrared light, near-infrared light, visible light, and ultraviolet light for a therapeutic effect when used intraorally and extraorally.

10. The vibration device of claim 1 wherein the intraoral attachment includes a brush tray that is configured to receive a row of teeth of the user.

11. The vibration device of claim 10 further comprising a motor that is configured to selectively vibrate the intraoral attachment relative to the row of teeth when the intraoral attachment is coupled to the device body.

12. The vibration device of claim 1 wherein the extraoral attachment includes a massage head.

13. The vibration device of claim 12 wherein the massage head includes a head base and a plurality of protruding members that are coupled to and extend away from the head base.

14. The vibration device of claim 12 wherein the massage head includes a head base and a massage pad that is coupled to the head base.

15. The vibration device of claim 12 wherein the massage head includes a head base and one or more massage balls that are coupled to the head base.

16. The vibration device of claim 12 further comprising a motor that is coupled to the device body, the motor being configured to selectively vibrate the massage head when the extraoral attachment is coupled to the device body.

17. The vibration device of claim 1 wherein the device body includes a body connector member, and wherein the intraoral attachment and the extraoral attachment alternately and removably connect to the body connector member.

18. The vibration device of claim 1 further comprising a motor that is coupled to the device body, the motor generating vibration, wherein one of the intraoral attachment and the extraoral attachment includes a connector shaft that is configured to directly engage the motor and receive the vibration from the motor.

19. The vibration device of claim 1 further comprising (i) a body connector member; (ii) an intraoral connector member configured to engage the body connector member when the intraoral attachment is alternately and removably coupled to the device body; and (iii) an extraoral connector member configured to engage the body connector member when the extraoral attachment is alternately and removably coupled to the device body

20. A vibration device for use by a user, the vibration device comprising:
a device body;
a body connector member that is connected to the device body;
an intraoral attachment that is configured for intraoral use by a user, the intraoral attachment selectively engaging the body connector member;
an extraoral attachment that is configured for extraoral use by the user, the extraoral attachment selectively and alternately engaging the body connector member; and
a motor coupled to the device body, the motor being configured to selectively vibrate (i) the intraoral attachment when the intraoral attachment is coupled to the device body, and alternately (ii) the extraoral attachment when the extraoral attachment is coupled to the device body.
